(19) United States
(12) Patent Application Publication
(10) Pub. No.: US 2009/0202105 A1
(43) Pub. Date: Aug. 13, 2009

(54) AUTOMATIC LICENSE PLATE RECOGNITION SYSTEM INTEGRATED IN AN ELECTRONIC TOLL COLLECTION SYSTEM

(75) Inventors: Arnaldo Joaquim De CASTRO ABRANTES, Carcavelos (PT); Pedro Miguel TORRES MENDES JORGE, Carcavelos (PT); Bruno Filipe FIALHO BASILIO, Carcavelos (PT)

Correspondence Address: SUGHRUE MION, PLLC, 2100 PENNSYLVANIA AVENUE, N.W., SUITE 800, WASHINGTON, DC, 20037, US

(73) Assignee: BRISA-AUTO ESTRADAS DE PORTUGAL, S.A., Carcavelos (PT)

(21) Appl. No.: 12/367,018

(22) Filed: Feb. 6, 2009

(30) Foreign Application Priority Data
Feb. 7, 2008 (PT) 103960

(51) Int. Cl. G06K 9/00; H04N 7/18; G06Q 30/00; G06Q 50/00

(52) U.S. Cl. 382/100; 382/105; 348/149; 705/13; 348/E07.085

(57) ABSTRACT

This invention relates to an automatic license plate recognition system referred to as ALPR—Advanced License Plate Recognition—which is integrated in an electronic toll collection system such as “Via Verde”—single-lane freeflow—, multi-lane (Open Road Tolling), manual lane, semi-automatic lane, or any other solution involving the automatic license plate recognition. It is basically characterized by the following: taking of a panoramic picture of the back of the vehicle for visual inspection; automatic (by image recognition), recognition of the vehicle's license plate, checking both the rear and front license plates; generation of a final photograph in the JPEG (“Joint Photographic Expert Group”) format, apposing rear and front license plates to the panoramic image, as well as inserting data on time and place; independence between the quality of the generated photos and from variables such as light, climate conditions and license plates' quality, among other aspects; thus comprising for that purpose: a camera system for image acquisition; an automatic license plate recognition system (“engine”) referred to as LPR (“License Plate Recognition”); a composition module (12) and generation of the final photo; and a certification module Cert (13) and digital signature of the final photo.

### FIELD OF THE INVENTION

This invention relates to an automatic license plate recognition system hereinafter referred as ALPR (Advanced License Plate Recognition), which is integrated in an electronic toll collection system, such as “Via Verde” (the Portuguese system—literally “Green Lane”), manual lane, semi-automatic lane, multi-lane or any other solution involving the automatic license plate recognition based in the ALPR system, the latter being fitted with a certification module for the generated photos, allowing them to be used as an evidence in the scope of payment disputes.

### SUMMARY OF THE INVENTION

The ALPR system generates a composed photograph that is based on the processing of a set of images from which the front and rear car plates are extracted. The resulting photograph corresponds to a panoramic image of the viewable area, covering the rear side of the vehicles. To the resulting photograph is also apposed the identification data of the lane where it was taken, as well as a time indication.

The ALPR system, which is comprised of a set of video cameras and its respective photograph processing system, can be used in “Via Verde” lanes, manual lanes, semi-automatic lanes, multi-lanes, parking lots or any other application where the automatic license plate recognition is required. However, the “Via Verde” being the one corresponding to the context of development, it was the one selected as framing and demonstration application. The ALPR system and its services are also considered as being part of the services bus in which is based the toll collection systems' management infrastructure, hereinafter referred to as ITS-IBus (Intelligent Transport Systems Interoperability Bus”).

### BRIEF DESCRIPTION OF THE DRAWINGS

The following description is based on the enclosed drawings which, with a non-limitative character, represent:

FIG. 1, the general architecture of the toll management system;

FIG. 2, the systems involved in the flow of a photo generation process in the ALPR system (1);

FIG. 3, presents the functioning of the ALPR system (1), wherein the double capture of images is used in the event of a vehicle crossing the lane, by means of a rear module and a front module, in order to generate a JPEG-format final photo with apposition to the panoramic image of the front and rear car license plates, as well as additional information on place and time (time indication);

FIG. 4, the general architecture of an ALPR system (1);

FIG. 5, a detail view of the ALPR (1), using Infra-Red and visible spectrum;

FIG. 6, a photograph generated by an ALPR system (1);

FIG. 7, the use of image double capture, by means of a rear module (14) and a front module (15);

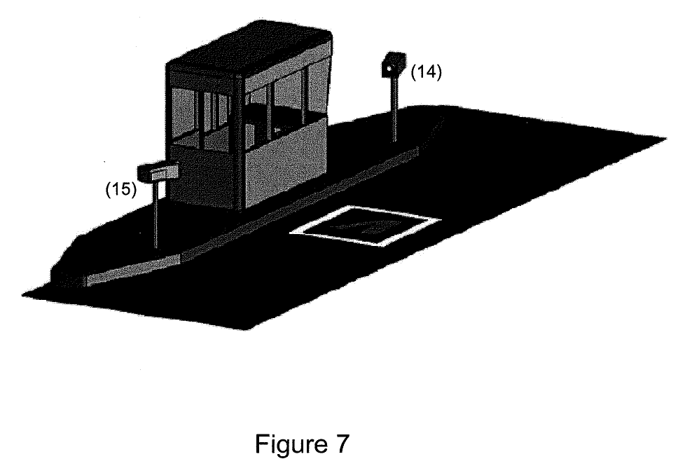

FIG. 8, the flow of photographs between the Entity generating them and the Court; and

FIG. 9, the generation model of the integrity controlling system.

### DETAILED DESCRIPTION OF THE INVENTION

The principle of the electronic toll collection (ETC), in the “Via Verde” system and in multi-lane, takes place with a transaction being initiated by the communication between the device installed in the vehicle, which is called “On Board Unit” (OBU), also known as Via Verde identification tag, and the antenna located at the “Via Verde” lane, using the Dedicated Short Range Communications technology, hereinafter referred to as DSRC (2), and microwave communication (5.8 GH). The identification tag contains information which allows the owner's identity as well as the class of the vehicle to be accessed, i.e., information that makes possible to determine who is the person from whom the toll shall be collected and the relevant amount. Whenever a vehicle passes the lane in irregular situation, the ALPR system (1) generates a photograph which may be used later as evidence in the collection proceedings to be started.

The photographs generated in an ALPR system (1) are sent by the private and secure network of data communication to the operations central system. The photographs are processed (checked) in this service by a mixed process, automatic and manual, giving rise to collection proceedings through a notification being given to the offenders in case the toll's non-payment is proved.

It is a concern of this invention to demonstrate the idoneity (security, privacy and accuracy) of the ALPR system (1), this being intended to be compliant with the laws in force as regards the processing, in digital format, of legally valid information (court evidence). Therefore, in the defense of the security model all the applicable standards are considered, namely those governing the aspects related to the accreditation of certifying bodies. This is due to the fact that the digital signature technique is used in order to guarantee the integrity and idoneity of the photographs generated by ALPR systems (1).

The following elements are deemed as critical as regards the procedure for certification of this ALPR payment collection monitoring system:
Description of the logical architecture of the toll management system, which is based on a distributed system wherein the ALPR system (1) is included.
Description of the process for taking the picture, including the images of rear and front number plates that are apposed to the final photograph, to which is then added the information on time and place.
Introduction of security mechanisms in compliance with the laws in force, governing the probative value of digitally processed data.

The aforementioned three elements will be hereinafter approached as an integral part of what is being proposed, i.e., the security model of the automatic processing system for the collection control, which is based on the license plates of the vehicles passing through the toll lanes.

Architecture of a Toll Management System

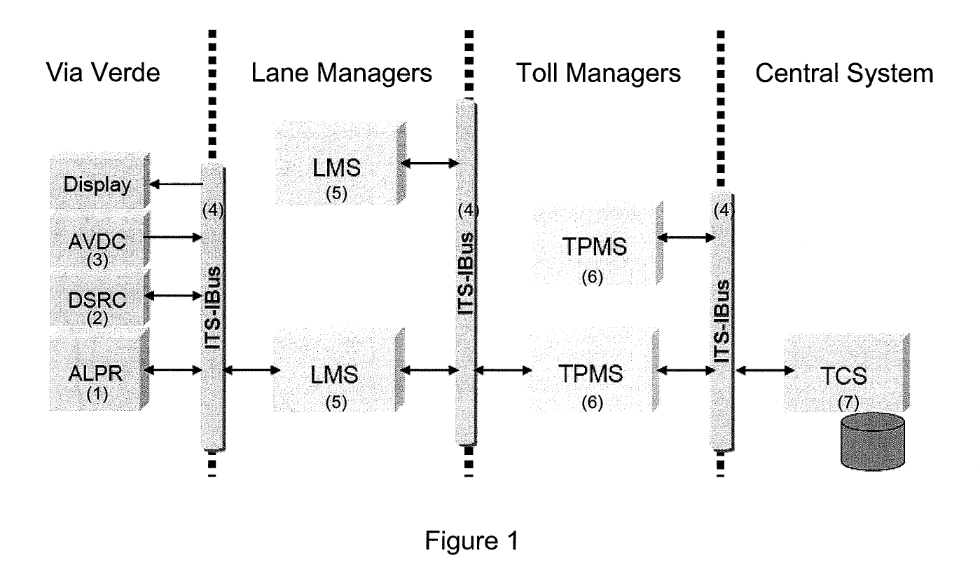

As shown in FIG. 1, the toll system is comprised of four control levels, from the lane systems (lane level), to the lane coordinators' level, the toll coordinators' level and, finally, the central coordination system. Each one of these levels communicates with its adjacent levels by a service-based communication Bus, the above-mentioned ITS-IBus (4). The ITS-IBus (4) defines a set of basic services such as security, configuration and administration mechanisms, and also the so-called “plug-and-play” mechanisms. In addition to the basic services established for each class of system, a number of services are defined to be promoted as standard services, which are designed to be implemented by all the suppliers.

The lane management level implemented by lane management systems, hereinafter referred to as LMS (5), is aimed both at monitoring the vehicles' passage process and effecting transactions according to each specific situation. Among the circumstances to be considered by a LMS (5), reference is made herein to the passage of a vehicle without carrying an identification tag, or with a low battery tag, and a classification error. In case of a failure occurring in the transaction due to the LMS (5), the ALPR (1) will collect evidence of the eventually offending vehicle passing through the lane. The said evidence is requested by the LMS (5) to the ALPR (1) and corresponds to the production of a photograph which covers the rear side of a vehicle.

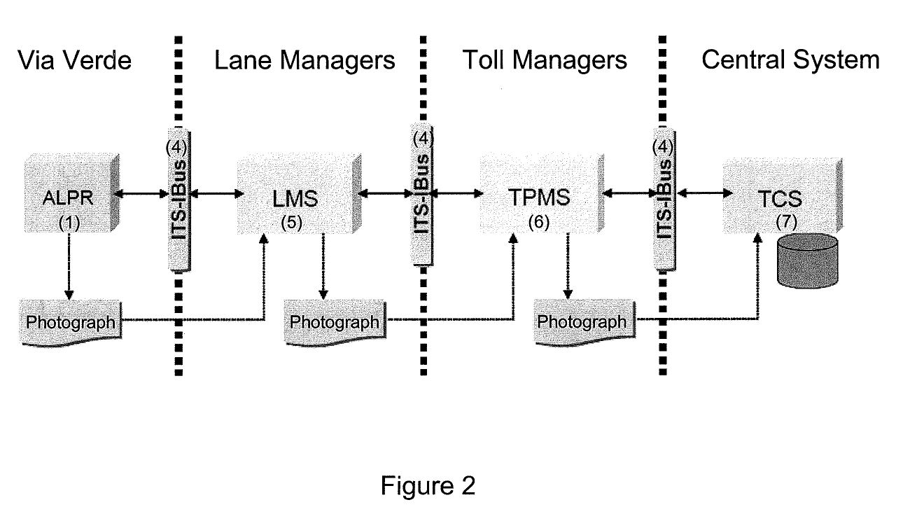

The photograph received by the LMS (5) (see FIG. 2) is then sent to the Toll Plaza Management System, hereinafter referred to as TPMS (6), to which it is connected, said photograph being stored and subsequently sent to the central system. This means that the photographs produced at the ALPR (1) systems' level are associated to events generated on the lane systems/equipments (DSRC (2), Automatic Vehicle Detection and Classification hereinafter referred to as AVDC (3)), and results in a message which is conveyed through the private (secure) network infrastructure of the concession company, from the equipments where it is generated up to the processing system.

Once arrived to the central system, those messages will enable the toll payment to be processed, in case there is a toll payment and, for exceptional situations, the associated photograph allows an enforced payment process to be sustained or even a legal action to be started which will eventually be settled in court.

An ALPR system (1) generates a photo of the back of the vehicle in JPEG format (Joint Photographic Experts Group), where, in a set of headers (18), additional information (metainformation) is displayed, so that it can be then assessed by other (automatic) toll payment management systems. Some aspects are hereunder presented in detail which are relevant for a better understanding of the proposed technological solution, as well as the quality statement as regards the security of the obtained results.

The value, as legal evidence, of a photograph which has been generated in an ALPR system (1) does not depend exclusively on this system. In effect, there is a series of other systems and processes integrated in a toll management system which also account for the integrity and originality of the photographs thus produced. Among these processes, the management model of technological systems is highlighted in aspects related to equipments' accessibility.

All the systems forming the technological infrastructure of the toll collection system have an integrated private network, which enables no external access and is thus protected against any attacks within Internet's open space. Although an Ethernet network with IP network protocols is used as the infrastructure of the communication network between toll systems, the security mechanisms of the ITS-IBus (4) will ensure the control of accesses to the information, and also the integrity of the conveyed data in the communication network. This means that all the infrastructure systems and services are associated to an unique code and use secure communication mechanisms.

Description of the ALPR System (1) within the Context of “Via Verde”

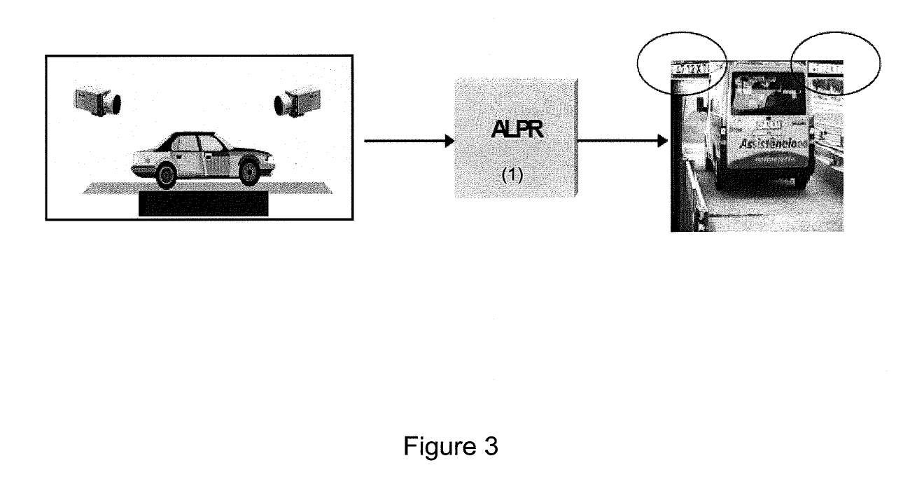

The process for monitoring payment collection in a specific toll lane includes an ALPR system (1). The role of each ALPR (1) in the global system comprises the production of an electronic document (photograph plus metainformation) enabling the identification of the vehicle, the place and time of passage, whenever required by the relevant LMS (5) in the event of a vehicle passing the lane. In terms of entries/exits, the system is illustrated in FIG. 3.

Therefore, the primary requirements of the ALPR (1) are the following:
the taking of a panoramic picture of the back of the vehicle for visual inspection;
the acquiring infra-red images from the front and the back of the vehicle for automatic license plate recognition;
automatic recognition of the vehicle's license plate, checking both the rear and front license plates;
the generation of a final photograph in the JPEG format, apposing rear and front number plates to the panoramic image, as well as inserting data on time and place (time indication);
independence between the quality of the generated photos and variables such as light, climate conditions and license plates' quality, among other aspects; and
The picture taken from the front, the selection of the license number area only, which is to be apposed to the final photograph, the remaining of it being immediately destroyed.

This system has been developed based on artificial vision techniques which are used for the purpose of license plate detection and recognizing its characters.

Logical Architecture

In the solution adopted for the ALPR system (1), two main steps are considered:
i. the obtainment acquisition of a picture for visual inspection, in which the back of the vehicle is shown, framed in the toll lane where it was taken;
ii. The acquisition of infra-red images from the front and the back of the vehicle;
iii. the automatic recognition of the characters of one or more license plates, making use of optical character reading techniques, known as OCR (Optical Character Recognition), along with an automatic license plate recognition system, hereinafter referred to as LPR (11), and using images which are different from the one mentioned in paragraph i).

For the automatic recognition procedure, maximum contrast and resolution are required at the area of the photograph showing the license plate, the remaining of the vehicle's image not being important to that end. It should be noted that, in order to recognize the license plates of several types of vehicles, in particular of heavy vehicles, rear and front side photographs must be taken. With this strategy, in addition to the license plate recognition in heavy vehicles—two procedures being initiated for the recognition of front and rear license plates—it is possible to establish a value for the confidence level in conformity, in case of the two values matching each other.

Given that, only the visual inspection is considered for legal purposes, the photograph must include a panoramic view of the back of the vehicle, so that people are able to identify its characteristics, such as the car's brand, model, colour shade, class, and the toll area where the picture was taken. This ensures the separation between the issue of recognizing a license plate and the one of providing documents for legal examination of the offense. In both cases, no information is registered which would allow to identify the car's occupants. In other words, from the front side image only the license plate area is apposed to the photograph generated by the ALPR system (1). Apposing the rear and front license plates to the photograph produced by the ALPR system (1) will provide a well-founded visual confirmation and, in addition to the characteristics of the vehicle as shown in the panoramic picture, also the license plates captured by the cameras operating in the infra-red range can be checked.

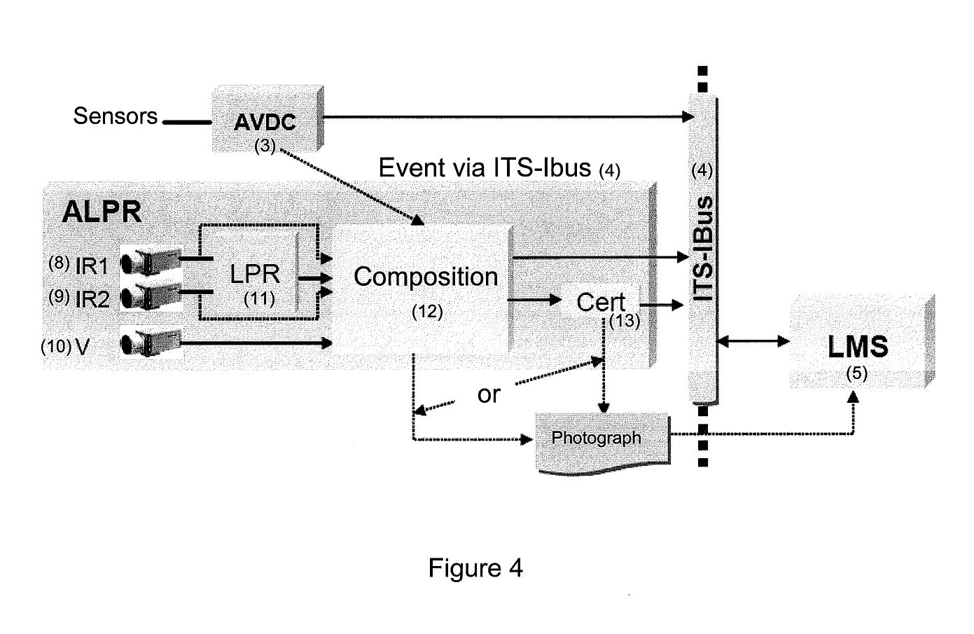

The logical architecture of an ALPR system (1) is illustrated in FIG. 4, and is comprised of the following:
a system with a set of cameras for image acquisition (distinguishing the automatic recognition from the visual inspection):
a recognition system (“engine”) named LPR (11);
a composition module (12) and generation of the final photograph; and
a certification module (13) and the digital signature of the final photograph (Cert.).

An ALPR system (1) generates a photograph with information apposed to the image—by the composition module (12)—including rear and front license plates, as well as information on location (identification of the place where it was captured) and time (insertion of time indication, with the moment wherein it was captured). Only the final photograph, which is produced by the composition module (12), and either or not accompanied by the digital signature produced by the certification module (13), is stored on the system. The images captured by the front and rear cameras are used only for the purposes of automatic recognition and to obtain the number plates to be apposed to the final photograph. So, under no circumstances, are they stored or accessed by any process, to the exception of the one of automatic license plate recognition.

The composition module (12) generates a JPEG image, based on a panoramic photograph of the back of the vehicle, which is composed with selected cropped sub-images of the front and rear license plates, whose location is provided by the LPR (11) recognition engine. The JPEG format also enables the use of headers (18) in order to include additional information (metainformation). Said additional information includes:
Front and rear license plates in text format, these being provided by the LPR (11) recognition engine;
Class of the vehicle, this being provided by the AVDC system (3); and
Supporting data to the photographs' authentication model, these being provided, where applicable, by the certification module Cert (13).

The services made available by ITS-IBus (4) in order to obtain the photograph in JPEG format, in its signed mode by the module Cert (13), or in its non-signed mode—and in this case without the intervention of the module Cert (13), enable the ALPR system (1) to be installed in places where its access is done by means of an unsecure network. In case of tolls wherein the systems are interconnected by a private and secure network, the qualified electronic signature is entered into the central system only when the photographs are conveyed in association with a legal action that has meanwhile been started.

Physical Architecture

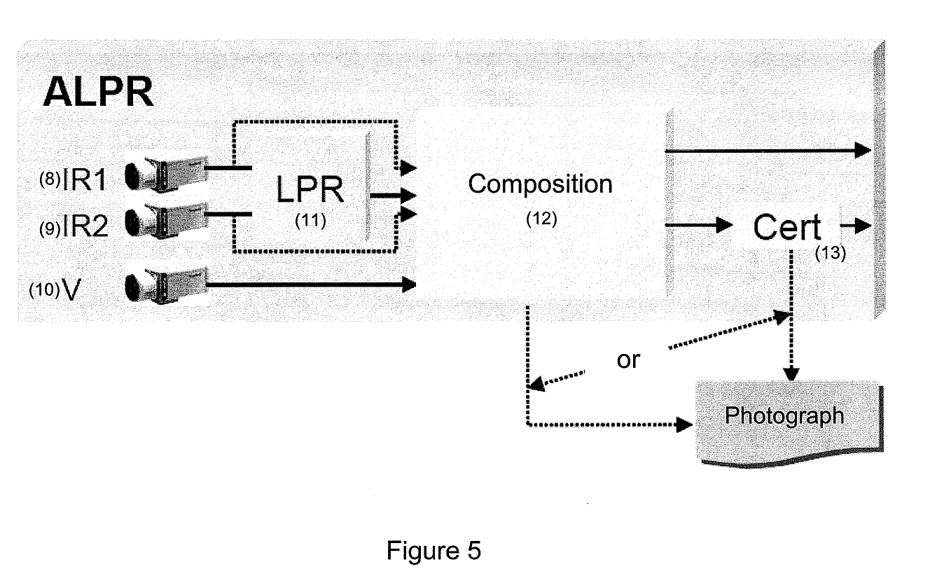

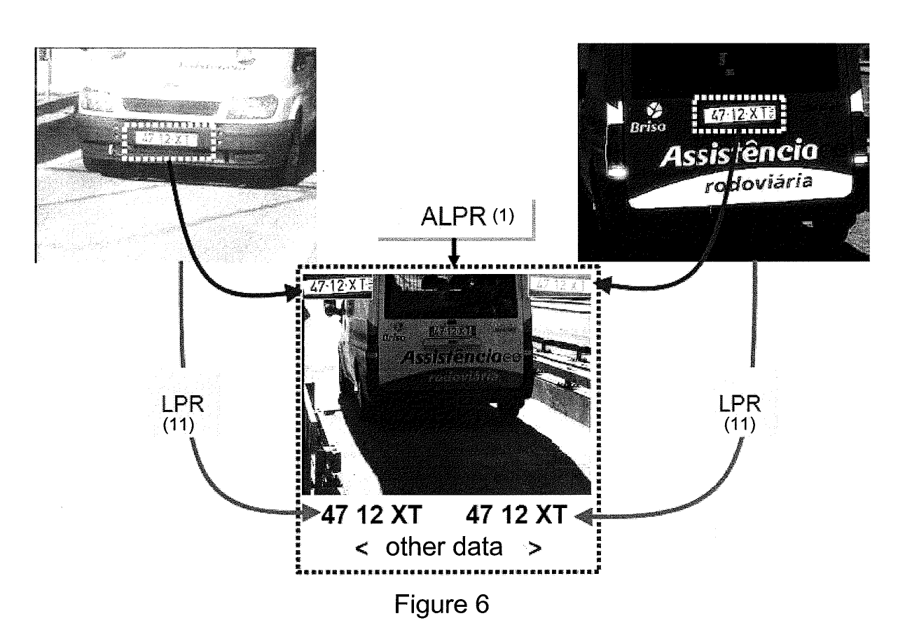

A high-contrast image is required for a good automatic identification of the license plate and this, to the maximum extent possible, irrespectively of the existing external lights. A frequently adopted solution, which is being used also in this ALPR system (1), comprises capturing images using Infra-Red radiation, hereinafter referred to as IR, aimed at recognizing and obtaining the number plate thus filtering all the radiation in the visible spectrum. Therefore, the infra-red sensitive cameras, which are positioned towards the front and rear sides of the vehicles, will provide an enhanced quality image of the license plate's specific area. These images are used for the purpose of obtaining the number plates to be apposed to the final photographs, and will also support the LPR (11) recognition engine to obtain the number plates in text format (see FIGS. 5 and 6). These images will only be in the ALPR (1) system's memory, in order to be used for the production of the final photograph, and they will never be stored or transmitted by any process.

For each vehicle passing through a toll payment lane in an irregular situation, 3 photographs are captured:
IR image of the front side;
IR image of the rear side;
Coloured viewable image of the rear side, with a wide field of view so that the car's type, brand and model can be identified.

The license plate's location supplied by the recognition engine is used to create a composite image, based on the viewable image with a wide field of view, to which the sub-images will be juxtaposed in the upper left and right sides with the front and rear license plates, respectively, which have been extracted from the corresponding IR photographs. This composite image is saved in a JPEG format file.

Only said JPEG image is stored in disk and sent in response to a request of the system to which the ALPR (1) is connected. The two IR images and the viewable image (the original ones) are immediately deleted. These images will exist physically in the PC's memory for only a couple of fractions of second. Therefore, it will not be possible, afterwards, to identify the occupants from this front image.

The images captured by the two cameras operating in the infra-red spectrum (IR1 (8) and IR2 (9)) are processed by the LPR (11) module in order to recognize the rear and front car license plates. From these two photographs is extracted the specific part of the license plate, the said photographs being then associated to the image captured by the camera in the visible spectrum V (10) using the composition module (12). From the resulting photograph, and after the headers (18) have been associated, a JPEG-format photograph is generated to be sent through the technological infrastructure, which is comprised of the LMS (5) and TPMS (6) systems, and this in the case of an ALPR system (1) being integrated in the toll payment system.

The camera of the front module (15) is connected to one of the video acquisition card channels by a coaxial cable.

The rear module (14) is similar to the front module (15) described in the above paragraph.

The photos' acquisition is physically carried out in the same computer as the LMS (5) and these photographs will be used as an evidence of toll's non-payment.

As previously mentioned, the ALPR system (1) may be integrated into other systems requiring an automatic recognition of vehicles' license plates. This being an autonomous system, its security and the documents' security must be assessed in each specific context.

Proposed Security Model

The objective of defining a security model for the photographs, and the respective metainformation as generated by an ALPR system (1) is to establish a legal framework as regards the collection monitoring data being produced by these systems. Thus, it is considered a critical goal that the evidence produced by an ALPR system (1), i.e. photographs of the rear side of vehicles, can be used as an evidence within the scope of court settlement of potential disputes. The latter may be related to the toll's payment when arising from an undue passage in a Via Verde's lane, or to any other situation where the photograph that has been generated by an ALPR system (1) is used as evidence in disputes to be legally settled.

The security model considers two main scenarios:

In the first one, the ALPR system (1) is integrated into a private and secure network and, in this case, the authentication of the generated photographs is required only when they are redirected by the source entity to the legal sphere, in order to be used as documentary evidence.

The other one relates to the use of an ALPR system (1), this being interconnected to a communication infrastructure where the security (privacy, integrity and authentication) of the exchanged data is not guaranteed.

Security Requirements and Risks

It is a primary objective of this security model to define the risks when assessing the idoneity of photographs generated by an ALPR system (1). It is intended that, by means of a specialized application, an indication is provided in respect of the authenticity of a photograph which has been produced by an ALPR system (1). Ultimately, a Court shall have the possibility of checking a photograph generated in an ALPR system (1) and if the information contained therein has been changed in any way, this must be duly pointed out. Furthermore, there must be an evidence of idoneity as regards the photograph whenever a court's application decides for its validation.

A photograph being generated in an ALPR system (1) and circulated via the supporting computer infrastructure until it is stored and conveyed according to the relevant procedures requires that any attempt of attack is detected. Among the risks considered as regards a photograph generated by an ALPR system (1), reference is made to the following:

1. An ALPR system (1) is replaced by an equivalent system but which is false, resulting from a replication being developed by acceding to the technology;

2. An ALPR system (1) is modified by introducing a software into the computer which clears the way for a potential invader, whether during a maintenance procedure or by unauthorized access via the private network:

3. Someone having access to the physical network and visualizing the transactions (message interchange) within the network (i.e, intercepting messages, this being called “Eavesdropping”);

4. The access to the photograph (a JPEG file) by a person within the organization and causing its modification, for instance, altering the image by changing one of the characters in the license plate;

It is intended that the integrity of the information to be used as evidence (photograph and related information) is absolutely free of any suspicion in what concerns the violation of integrity, and its idoneity must be ensured.

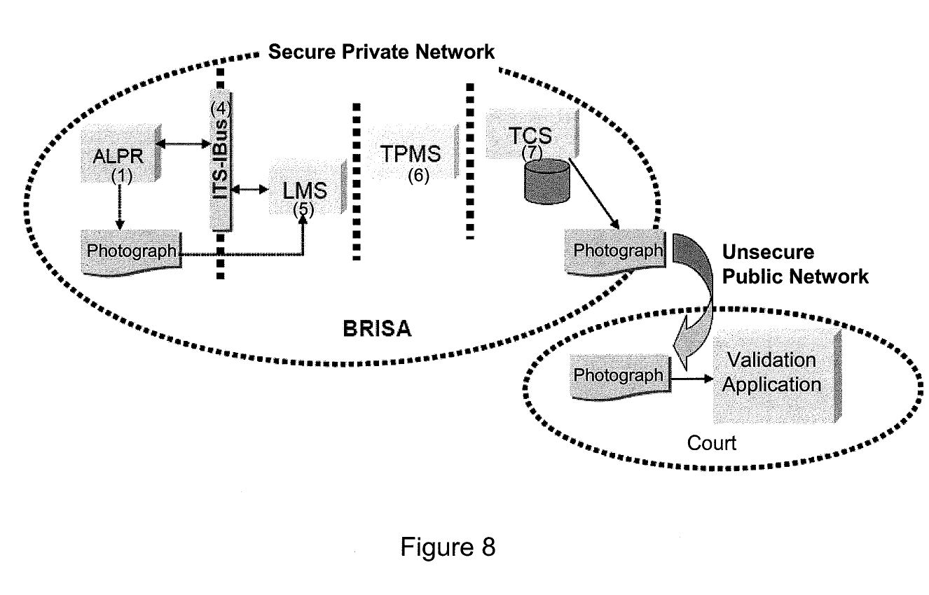

Assuming the interconnection of an ALPR system (1) in an example as the one in the scheme of FIG. 8, the security requirements for certifying the idoneity of photographs produced in an ALPR system (1) are the following:

1. The procedure for the production of a photograph must be secure, the latter being always produced by an idoneous ALPR system (1), wherein any attempt of fraudulent production would give rise to an exceptional circumstance;

2. Any modification to a photograph generated by an ALPR system (1) must be detected by a validation application; and

3. The capacity to validate a photograph must be extended up to the period of time established according to the terms of law in force.

It should be mentioned that, as happens currently with documents being manipulated by exclusively manual processes, the whole set of procedures and persons involved in the overall cycle of the photograph's production and management, as generated by an ALPR system (1), also contributes to the security of electronic documents. This means that, in addition to the technological aspects, the certification of procedures associated to the production of signed photographs is deemed as essential, and in particular the management of systems aimed at entering the signature. However, it shall be noted that this concern has the same ground as the authentication of any other document being produced by a given entity and which will be subsequently presented as evidence in the scope of a legal action. Additionally to technological and procedural aspects, which are duly certified, there is also the idoneity of the entity giving the evidence, this entity being responsible as to the idoneity of the (electronic or non-electronic) documents which have been produced.

Security Strategy Adopted

As previously mentioned, when detecting an exceptional situation where the acquisition of a photograph is required in order to be used later as an evidence, the ALPR system (1) will generate, at the level of a built-in processor, a photograph according to what was described above. The photograph is generated on a sealed system which causes it to disconnect and activates an alarm in case of any attempt to violate its integrity. Even if the system is removed from the lane, the coordination system will detect this event (the absence of one of the ALPR systems (1)) and launch an investigation procedure in order to clarify the reason why the system was disconnected from the infrastructure. Said procedure will check if there was an electronic or mechanical (physical) failure, and it will not be ended until the situation of the respective ALPR (1) is solved, i.e., when the system is “accepted” again for the production of photographs.

Therefore, the technological platform used for the management of the toll collection system (in the context of “Via Verde”) guarantees the integrity of all the lane systems which are connected to it, and the monitoring system will detect any malfunction irrespectively of this resulting from a natural cause or from an external attack or system invasion. This integrity is ensured by a system of sensors installed in the physical systems, which are associated to a set of events being generated whenever there is an exceptional circumstance and also as a result of a lack of communication between the coordinators and the systems to which it is connected.

The security procedure applied to a photograph consists of a Public Key Infrastructure, hereinafter referred to as PKI, associating to the photograph a qualified electronic signature which is based in digital signature. As previously mentioned, this signature may be or not be effected in the ALPR system (1). In the case where the infrastructure to which the ALPR systems (1) are connected is secure, the signature will only be entered at the central system's level. That is, the module Cert (13) will or will not be activated depending on the specific model of the technological infrastructure to which the ALPR system (1) is connected.

In the case where the photograph's signature is generated in the ALPR system (1), the private key (17) for which a valid certificate was issued by a competent certifying body, is securely accessed and used. In cases where the signature is entered at the central system, a similar procedure is followed in order to ensure that the photograph has not been modified, since photographs are conveyed through a private and secure infrastructure.

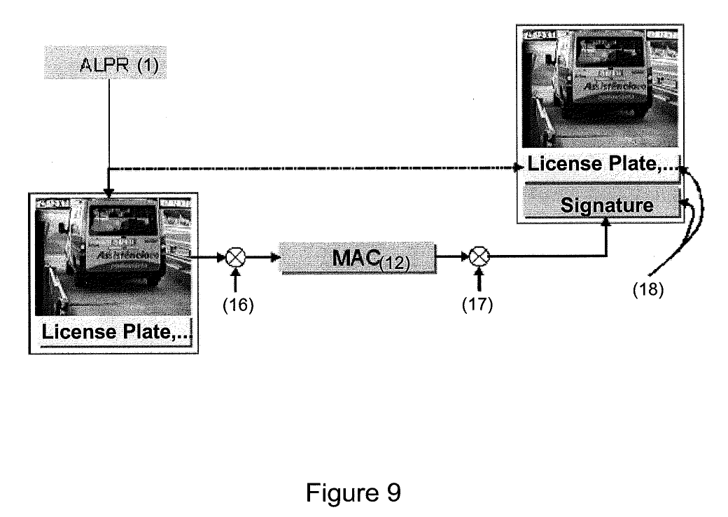

The signature process is based on a private key (17) which is the responsibility of the operator using it, so as to sign the result of a condensing/compressing function, hereinafter referred to as Digest (16), and on the message authentication code, hereinafter referred to as MAC, which is the result of the Digest (16) function application to the JPEG image and headers (18) produced meanwhile. The cipher of this MAC originates the digital signature which can only be checked by the relevant public key. The digital signature thus produced is associated to the respective JPEG file and to the original headers, so that an authenticated photograph is created which is susceptible of being subsequently validated as shown in FIG. 9.

The key pair (public, private) used in the security procedure of the photographs generated in an ALPR system (1) is associated to a certificate being issued by a certifying body in compliance with the laws in force.

Comparison with a Procedure Based in Watermark

An alternative to digital signature is the use of the so-called digital watermark. This technique is directed mainly to the settlement of disputes related to authenticity and copyright, allowing to address situations of unauthorized copy, falsification and vandalism.

A digital watermark is a signal which is inserted into the content to be protected, the latter being either in the form of an audio signal, an image or a video sequence. Unlike the digital signature, which is in general concatenated to the content without altering it, the watermarking produces, in most cases, an irreversible change in the original signal. Usually, this change is imperceptible to the user. Logotypes and letters are common examples of watermarks inserted into images, but any signal can be used to this end.

There are three main types of algorithms for insertion of the watermark into the content: they are named as fragile, semi-fragile and robust watermarking techniques. These terms relate to the watermark's invariance in the presence of changes being made to the content. It should be noted that said changes may be or not be of a malicious character. The destructive compression of an image (particularly one using the JPEG standard) is a common example of a non-malicious change, as well as the filtering and the equalization of histogram which are aimed at improving the perceived quality and contrast.

Fragile watermarks resist to no transformations in the content whatsoever. This behaviour is intentional, so that any kind of vandalism or falsification can be detected. However, this makes the compression impossible, except in the case where the watermark is applied after the destructive part of the compression process (i.e. in the domain of frequency, by applying the watermark to the Discrete Cosine Transformation coefficients (referred to as DCT) in the case of JPEG).

As to the semi-fragile watermarks, these are intended to resist to non-malicious transformations. A strong effort is being made in the field of scientific research focused on effective techniques for the insertion of semi-fragile watermarks, which are able to satisfy the double requirement of invariance to compression/filtering/equalization and sensitivity to any deliberate falsification of content.

Robust watermarks, in their turn, have the opposite objective: they are designed to resist, to the greatest possible extent, to a number of transformations, irrespectively of these being linear or non-linear, malicious or non-malicious transformations, in order to detect the presence of the watermark and prove the content's origin. A typical example is the survival to the scanning and/or printing process. Usually, the application of robust watermarks is related to the copyright protection, rather than the detection of falsifications.

Application to the Collection Monitoring System and Comparison with Digital Signature

In the collection monitoring system, the content to be protected consists of a photograph generated by the ALPR (1). In order to ensure that the photograph has not been the object of falsification, the most appropriate watermarking techniques are the fragile and—with fewer guarantees—the semi-fragile. Emphasizing the fragile watermarks in the domain of frequency, these being the ones which, as previously mentioned, allow the destructive compression to be continued with the JPEG standard, one can conclude that their use in this system, in replacement of the digital signature, would have the following advantages and disadvantages:

Advantage
It would be no longer necessary to keep the MAC concatenated to the image, and so the size (in bytes) of the JPEG file would be reduced. However, the reduction is not significant, since the MAC typically has some bytes of length and may be inserted into the header (18) of the JPEG file, with no need to retain additional data structures. It shall be noted that, anyway, headers (18) must already contain other information, such as data from the ALPR (1) module, date/time of image acquisition, and the like.

Disadvantages
The watermark is susceptible of disturbing the automatic license plate recognition process, although the impact of this is debatable—ideally, the recognition should always be made over the original image stored in memory, and also before the compression. If the watermark is inserted only in the domain of frequency, the recognition would have been made already. In effect, it is not clear if the water would cause or would not cause more disturbance than the JPEG's destructive compression process itself.
Inserting a watermark in the domain of frequency would imply to keep the control over the internal coding/decoding process of JPEG files, thus preventing the previously available standard functions from being used, namely in what concerns the recognition engine. This involves a greater effort of development and, consequently, higher costs.

### FIGURE CAPTIONS

1 ALPR (Advanced License Plate Recognition)
2 DSCR (Dedicated Short Range Communications)
3 AVDC (Automatic Vehicle Detection and Communication)
4 ITS-IBus (Intelligent Transport Systems Interoperability Bus)
5 LMS (Lane Management System)
6 TPMS (Toll Plaza Management System)
7 TCS (Toll Coordination System)
8 IR 1 (Camera operating in the infra-red spectrum)
9 IR 2 (Camera operating in the infra-red spectrum)
10 V (Camera in the visible spectrum)
11 LPR (License Plate Recognition)
12 Composition (Composition Module)
13 Cert (Certification Module)
14 Rear Module
15 Front Module
16 Digest Function
17 Private Key
18 Headers

1. An automatic license plate recognition system (ALPR (1)) which is integrated in an electronic toll collection system such as “Via Verde”, manual lane, semi-automatic lane, multi-lane, or any other solution involving the license plate automatic recognition,
said system being characterized by the following:
Taking of a panoramic picture of the back of the vehicle for visual inspection;
Acquisition of infra-red images from the front and the rear of the vehicle;
Automatic recognition of the vehicle's license plate, checking both the rear and front license plates;
Generation of a final photograph in the JPEG format, apposing rear and front license plates to the panoramic image, as well as inserting data on time and place;
Independence between the quality of the generated photos and variables such as light, climate conditions and license plates' quality, among other aspects;
thus comprising for that purpose:
A camera system for image acquisition;
An automatic license plate recognition system (“engine”) referred to as LPR (11);
A composition module (12) and generation of the final photo;
A certification module Cert (13) and the digital signature of the final photograph.

2. An automatic license plate recognition system according to claim 1, characterized in that the camera system for image acquisition is comprised of two infra-red sensitive cameras, which are positioned towards the front and rear sides of the vehicles and provide an enhanced quality image of the license plate's area, and also of one camera which is sensitive to the whole visible spectrum thus allowing the visual inspection of the vehicle, said cameras being mounted into modules (14, 15).

3. An automatic license plate recognition system according to claim 1, characterized in that the images captured by the infra-red sensitive cameras are used in order to obtain the license plates to be apposed to the final photograph, also serving as a support to the LPR (11) recognition engine so that the license plates are provided in text format.

4. An automatic license plate recognition system according to claim 1, characterized in that the images captured by the infra-red sensitive cameras exist only in the ALPR system's memory for the process of generation of the final photograph, said images being never stored or transmitted by any process.

5. An automatic license plate recognition system according to claim 1, characterized in that the viewable image of the camera which is sensitive to the visible spectrum has a wide field of view, in order to enable visual identification of the vehicle's type, brand and model.

6. An automatic license plate recognition system according to claim 1, characterized in that the images captured by the two cameras operating in the infra-red spectrum (IR1 (8) and IR2 (9)) are processed by the LPR (11) module so that the rear and front license plates of a vehicle are recognized, and only the specific part of the license plate is extracted from these images, which is then associated to the image captured by the camera in the visible spectrum V (10) using the composition module (12).

7. An automatic license plate recognition system according to claim 6, characterized in that, from the obtained photograph and after the headers have been associated thereto, a JPEG format photograph is generated which can be sent through the technological infrastructure, the latter comprising the lane management system LMS (5) and the toll plaza management system TPMS (6).

8. An automatic license plate recognition system according to claim 6, characterized in that the camera of the front module (15) is connected by a coaxial cable to one of the video acquisition card channels of the LMS system (5), which includes a supporting computer to the ALPR system (1), this system being responsible for the production of photographs which will then be used as an evidence of toll's non-payment.

9. An automatic license plate recognition system according to claim 8, characterized in that the camera-carrying modules (14, 15) are provided with a pulsed infrared light system which is synchronous with the video signal, this system having a modular architecture comprising four 54 LED modules and being equipped with a flash system, which will be activated only when images are acquired.

10. An automatic license plate recognition system according to claim 1, characterized in that, to the image captured by the camera in the visible spectrum V (10), it is possible to associate, by means of the composition module (12) and along with the images of the front and rear license plates captured by the recognition engine (11), additional information allowing to identify the class of the vehicle as provided by the automatic vehicle detection and classification AVDC (3), and also supporting data to the authentication model of the photographs being supplied by the certification module (13).

11. An automatic license plate recognition system according to claim 1, characterized in that the photographs' security process to be accomplished in the certification module (13) is based in a public key infrastructure (PKI), wherein qualified electronic signatures are associated to the photographs, based in a digital signature.

12. An automatic license plate recognition system according to claim 11, characterized in that the signature of the photograph can be generated in the ALPR system (1) or in a management central system of the toll collection system, guaranteeing in both cases that the photograph has not been the object of any modification.

13. An automatic license plate recognition system according to claim 1, characterized in that the technological platform for the toll collection system management ensures the integrity of all the lane systems being connected to it, so the monitoring system will detect any malfunction whether this results from a natural cause or from an external attack or system invasion, said integrity being ensured by a system of sensors installed in the physical systems, which are associated to a set of events being generated whenever there is an exceptional circumstance and also as a result of a lack of communication between the coordinators and the systems to which it is connected.

14. An automatic license plate recognition system according to claim 11, characterized in that the certification of the photograph can be performed using a watermark.
